(19) United States
(12) Patent Application Publication
(10) Pub. No.: US 2016/0085698 A1
(43) Pub. Date: Mar. 24, 2016

(54) DEVICE-SPECIFIC USER CONTEXT ADAPTATION OF COMPUTING ENVIRONMENT

(71) Applicant: Microsoft Corporation, Redmond, WA (US)

(72) Inventors: Petteri Mikkola, Bellevue, WA (US); Keri Kruse Moran, Bellevue, WA (US); Issa Y. Khoury, Redmond, WA (US); William Scott Stauber, Seattle, WA (US); Elizabeth Fay Threlkeld, Redmond, WA (US); Kenton Allen Shipley, Woodinville, WA (US); Ramrajprabu Balasubramanian, Renton, WA (US); Patrick Derks, Seattle, WA (US); Darren Ray Davis, Woodinville, WA (US)

(21) Appl. No.: 14/495,268

(22) Filed: Sep. 24, 2014

(51) Int. Cl. G06F 13/12; G06F 11/22; G06F 3/048

(52) U.S. Cl. CPC G06F 13/128; G06F 13/122; G06F 3/048; G06F 11/2289

(57) ABSTRACT

A user may interact with several devices of a device collection, and may utilize each device in a particular user context, such as driving a vehicle; relaxing at home; and attending meetings in a public location. The user may configure each device according to the user context of the user's interaction with the device. However, devices that are uninformed of the user context of the user's interaction with the device cannot adapt to the user context. Instead, a primary device of the device collection may detect various properties of each auxiliary device of the device collection and determine the user context of the user interaction with the auxiliary device. The primary device transmits to each auxiliary device, for presentation to the user, a user interface with elements of the computing environment adapted according to the user context of the user interaction of the user with the device.

### BACKGROUND

Within the field of computing, many scenarios involve an interaction of a user with a device collection, such as a laptop, a mobile phone, a tablet, and a media server. The user may acquire a variety of devices for the device collection in order to cover the user's interests and tasks, such as editing documents, viewing movies, driving a vehicle, and interacting with friends. The user may also tend to utilize each device in particular user contexts; e.g., the user may primarily utilize a laptop for academic or professional work, may primarily utilize a tablet during travel, and may primarily use the mobile phone during social events. To this end, the user may configure the computing environment of each device in view of the user context of the user in interacting with the device. For example, the user may load the laptop with applications for document editing; may load the tablet with applications for mapping, routing, and travel planning; and may load the phone with applications for capturing social interactions and interacting with social media.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Some scenario of user interaction with various devices of a device collection involve an adaptation of the user to the device, based on the user's intent to engage with the device in a particular user context. In such scenarios, the user has to choose the device configuration of each device to conform with the user context of the user interaction with the device. However, such user-driven adaptation may be difficult and/or onerous for the user to implement and maintain. In some cases, the user may not perceive an opportunity to configure a particular device for a particular user context, or may not have technical proficiency or resources to do so. Consequently, some devices and/or aspects may not adapt to the user context, and may provide generalized device functionality to the user, who may have to adapt the user's mental state and user interaction to utilize the generalized functionality of the device for the user context. Moreover, each device of the device collection either may present a shared computing environment that is generalized for each device, and therefore not well-adapted for particular user contexts; or may present an isolated computing environment that is specially configured for the user context, but that features limited coordination with the other devices of the device collection. As a still further difficulty, the user may fluidly use various devices in different user contexts, and it may be frustrating for the user to adapt a particular device or device subset to the user context of the user's current interaction with the device.

The techniques presented herein enable a device collection to adapt to the user context of the user, and to present a single computing environment on the respective devices in a manner that is automatically adapted to the user context of the user interaction of the user with the device. In accordance with such techniques, a primary device of the device collection that hosts a computing environment may detect various device properties of auxiliary devices of the device collection, such as the auxiliary device type and components; the applications and data stored upon the auxiliary device; the circumstances in which the user engages in a user interaction with the auxiliary device, and the tasks performed by the user in such circumstances; and other individuals and/or devices with which the user interacts while utilizing the auxiliary device. Such device properties of each auxiliary device may indicate the user context of the user interaction of the user with the auxiliary device. The primary device may therefore determine the user context of the user interaction of the user with each auxiliary device, and may adapt at least one element of the computing environment to be presented on each auxiliary device in view of the device-specific user context. The primary device may then transmit the computing environment to the respective auxiliary devices for presentation to the user. In this manner, the device collection may collectively engage the user according to the user's context in choosing to interact with particular devices of the device collection, in accordance with the techniques presented herein.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an illustration of an example scenario featuring an interaction of a user with a set of devices of a device collection.

FIG. 2 is an illustration of an example scenario featuring an interaction of a user with a set of devices of a device collection, in accordance with the techniques presented herein.

FIG. 3 is a flow diagram of an example method of enabling a primary device to present a computing environment to a user of an auxiliary device, in accordance with the techniques presented herein.

FIG. 4 is a component block diagram of example systems that enable a primary device and an auxiliary device of a device collection to present a computing environment to a user, in accordance with the techniques presented herein.

FIG. 5 is an illustration of an example computer-readable medium comprising processor-executable instructions configured to embody one or more of the provisions set forth herein.

FIG. 6 is an illustration of an example scenario featuring various device properties of various devices that may inform a determination of the user context of a user interaction of a user with the auxiliary device, in accordance with the techniques presented herein.

FIG. 7 is an illustration of an example scenario featuring a clustering technique for associating the device properties with respective user contexts, in accordance with the techniques presented herein.

FIG. 8 is an illustration of an example scenario featuring an adaptive algorithm that associates the device properties with respective user contexts, in accordance with the techniques presented herein.

FIG. 9 is an illustration of an example scenario featuring an adaptation of an application within the computing environment of respective auxiliary devices based on an information density of the user interaction of the user with the device, in accordance with the techniques presented herein.

FIG. 10 is an illustration of an example scenario featuring a notification routing of a notification according to the user contexts of respective auxiliary devices of a device collection of a user, in accordance with the techniques presented herein.

FIG. 11 is an illustration of an example computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

### A. Introduction

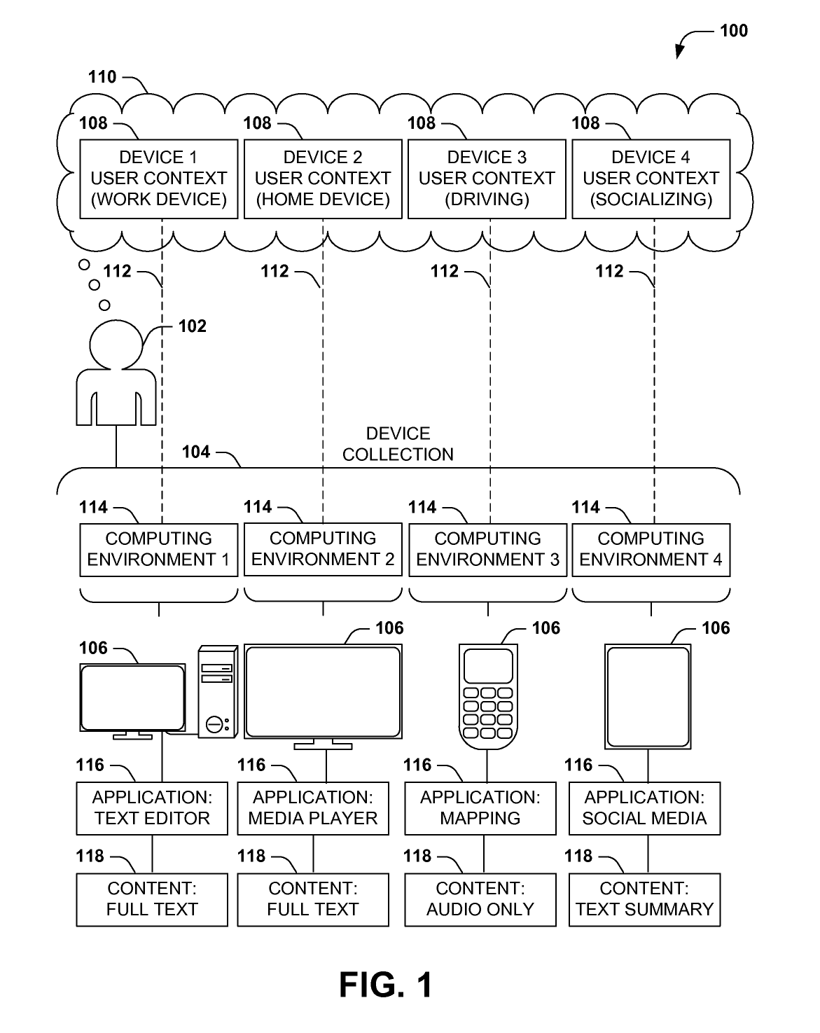

FIG. 1 is an illustration of an example scenario 100 featuring a user interaction of a user 102 with a device collection 104 comprising a set of devices 106. In this example scenario 100, the user 102 acquires the devices 106 to cover a broad set of interests and tasks, such as editing documents; viewing various forms of media; playing games; communicating with professional and social contacts; and discovering information that facilitates the user's day-to-day activities, such as vehicle mapping and navigation. Each device 106 of the device collection 104 may present a computing environment 114, such as a collection of applications 116 that are installed and executable on each device 106; various collections of data, such as user files, media objects, and web links; and various forms of user interfaces, such as operating systems adapted for casual and/or professional user interactions. Each device 106 may also feature a different set of components, such as displays of varying quality and resolution; speakers, headphones, and/or earpieces to provide audio output to the user 102; input devices such as keyboards, mice, and touch-sensitive displays; and other peripherals, such as cameras and communication devices.

More particularly, the user 102 may obtain and interact with each device 106 in a particular user context 108. As a first such example, the user 102 may obtain a first device 106, such as a workstation computer, for the specific user context 108 of performing academic and/or professional tasks, such as communicating with other individuals in an office or editing documents for a particular project. As a second such example, the user 102 may obtain a second device 106, such as a home theater server, for use with a large-screen television in order to view movies, play games, and engage in casual web browsing. As a third such example, the user 102 may frequently travel, and may therefore obtain a third device 106, such as a mobile phone, for the intended user context 108 of trip planning, navigation, and communicating with other individuals during travel. As a fourth such example, the user 102 may obtain and utilize a fourth device 106, such as a tablet, in the user context 108 of social interaction, e.g., capturing and transmitting personal photos to a social media site, and communicating and sharing data with the user's friends and family.

In order to use the device collection 104 in this manner, the user 102 may choose, configure, and utilize each device 106 according to the user context 108 within the mind 110 of the individual 102, i.e., with the user context 108 that the user 102 associates 112 with each device 106. For example, if the user 102 intends to interact with a workstation device 106 in the user context 108 of academic or professional work, the individual 102 may select and install particular applications 116 in the computing environment 114 of the first device 106, such as text editors and computational tools. Similarly, the user 102 may acquire the second device 106 for the user context 108 of a home entertainment device, and may therefore choose and/or supplement the device 106 with a set of peripherals that are suitable for the user context 108 (e.g., a theater-quality display and audio system; a high-powered graphics coprocessor; and a collection of gaming peripherals), as well as applications 116 and data that are suitable for home entertainment (e.g., media players, movies, music, and games). The user 102 may similarly configure and interact with the other devices 106 of the device collection 108 according to the specific user context 108 of the user interaction of the user 102 with each device 106. For example, the user 102 may wish each device 106 to perform a particular task in a particular way in view of the user context 108 of the device 106; e.g., the user 102 may configure each device 106 to present content 118 in a particular way, such as a full-text presentation, a text summary, or an audio-only presentation of a particular text article, based on the particular user context 108 of the user interaction of the user 102 with each device 106. In this manner, the user's interests in interacting with each device 106 are achieved through the careful selection and configuration of the each device 106 to suit the user context 108 in the mind 110 of the user 102.

However, the user's management of the device 106 in the manner illustrated in the example scenario 100 of FIG. 1 may result in a variety of disadvantages.

As a first example disadvantage, the device-specific configuration of each device 106 to match the user context 108 is driven by the intent and actions of the user 102; e.g., the user 102 has to choose, implement, and maintain the selection, configuration, and use of each device 106 to match the user context 108 of the device 106. For example, the user 102 has to identify the applications 116 to be installed on each device 106, and has to configure the behavior of the applications 116 to suit the user context 108 (e.g., configuring each device 106 to present content 118 in a particular manner). Such conception, selection, installation, and maintenance may be quite involved and time-consuming, and may therefore be difficult and/or tiresome for the user 102. Moreover, a failure to implement and maintain the distinct configuration of each device 106 for a particular user context 108 may result in inconsistencies and/or unexpected behavior; e.g., the user 102 may fail to realize that a particular application 116 that is associated with a particular user context 108 is not installed or available on a particular device 106, and may therefore experience an unexpected limitation of the device 106.

As a second example disadvantage, the components and computing environments 114 of some devices 106 may not be completely configurable to suit a particular user context 108. For example, the mobile phone 106 may feature only limited configuration capabilities, and may offer a computing environment 114 providing only generalized and/or comprehensive computing functionality that are not adaptable for the user context 108. The user 102 may therefore have to adapt his or her mental process and actions in order to utilize the device 106 in the user context 108. For example, a device 106 may be particularly used for traveling, and the user 102 may heavily rely upon select functionality (e.g., mapping, routing, location determination, restaurant recommendations, interacting with travel agencies, and communicating casually with colleagues in an office to coordinate travel plans), and may not utilize other functionality of the device 106 (e.g., playing games, editing documents, interacting with social media, and casual web browsing). However, the device 106 may offer the full set of functionality to the user 102 at all times, and the user 102 may be compelled to distinguish mentally between the device functionality and data that relate to the user context 108 from the device functionality and data that do not.

As a third example disadvantage, the configuration of the devices 106 by the user 102 to suit particular user contexts 108 may isolate the computing environment 114 of each device 106 from the computing environments 114 of the other devices 106. For example, as a device configuration of a device 106 is specialized for a particular user context 108 (e.g., configured to present applications 116, content 118, and other functionality to suit the user context 108), the computing environment 114 of the device 106 may diverge from the computing environments 114 of the other devices 106. Such divergence may disrupt the interoperation of the devices 106 of the device collection 104, such that a particular device 106 becomes a “silo” for a particular user context 108 in which the other devices 106 are unable to participate (e.g., the other devices 106 may not be capable of utilizing specialized data of the first device 106), and/or may create inconsistences in the computing environments 114 (e.g., the contact lists of different devices 104 may include different and possibly conflicting information, which may interfere with communication by the user 102 with such contacts). Alternatively, the device collection 104 may maintain consistency by enforcing and synchronizing a single computing environment 114 among the devices 106, but such synchronization may interfere with, and at times mutually exclude, the user-context-specific configuration of each device 106 of the device collection 104.

As a fourth example disadvantage, the user context 108 of the user 102 may be dynamic, such that the user 102 may have to switch user contexts 108 while interacting with a particular device 106 (e.g., while attending a social event, the user 102 may receive a call from a professional colleague). The user 102 may therefore have to make a mental shift from the first user context 108 to the new user context 108 (e.g., accessing a different network, different user accounts, a different set of documents, and a different set of applications). For example, the user 102 may have to alter the configuration of the device 106 to suit the new user context 108, which may be frustrating if the user context 108 of the user interaction of the 102 with the device 106 changes rapidly and/or frequently. Conversely, if the user 102 fails to perform such selection, the user 102 may inadvertently interact with the device 106 in the wrong user context 108 (e.g., accidentally sending mail form a first email account rather than a second email account). Alternatively or additionally, a particular device 106 that has been configured by the user 102 solely for a first user context 108 may not have the flexibility to adjust the computing environment 114 to the new user context 108 (e.g., offering a different set of applications). These and other disadvantages may arise from the user-driven configuration of devices 106 of the device collection 104 to suit the user contexts 108 of the user interaction of the user 102 with each device 106, such as in the example scenario 100 of FIG. 1.

### B. Presented Techniques

Presented herein are techniques for configuring a device collection 104 of devices 106 to determine automatically to the user context 108 of the user interaction of the user 102 with respective devices 106, and to adapt elements of a shared computing environment 114 presented to the user 102 through each device 106 to the user context 108.

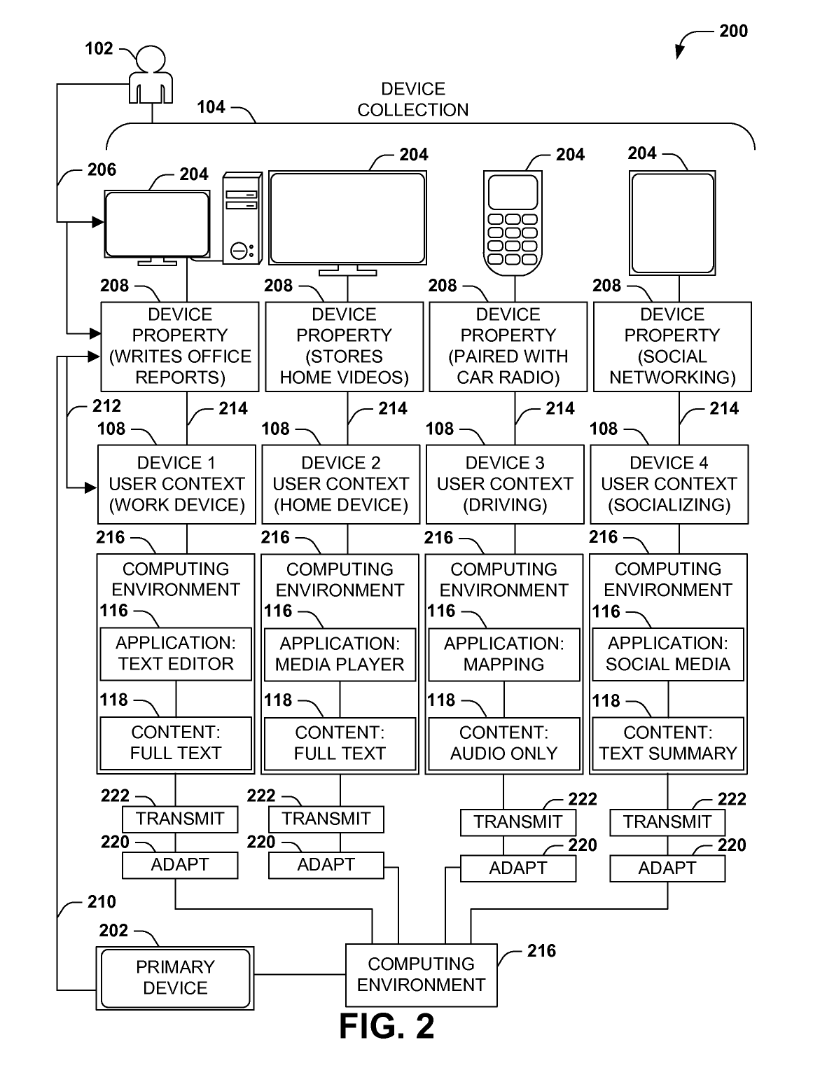

FIG. 2 presents an illustration of an example scenario 200 featuring a device collection 104 of devices 106 that are used by a user 102 in different user contexts 108. In this example scenario 200, the device collection 104 comprises a primary device 202, which hosts and/or manages a computing environment 216, and that transmits the computing environment 216 to a collection of auxiliary devices 204 that present the computing environment 216 to the user 102. The user 102 interacts 206 with each auxiliary device 204 in a particular user context 108; e.g., the first auxiliary device 204 may be used primarily in an academic or professional user context 108, including writing reports and contacting colleagues, while the second auxiliary device 204 may be used primarily as a home theater and entertainment device.

In accordance with the technique presented herein, the primary device 202 may adapt the computing environment 216 presented to the user 102 through each auxiliary device 24 in accordance with the user context 108 of the user interaction of the user 102 with the auxiliary device 204, in the following manner. The primary device 202 may detect 210 one or more device properties 208 of the respective auxiliary devices 204, such as the device type or class of the auxiliary device 204 (e.g., a server, a workstation, a laptop or netbook, a mobile phone, a tablet, a wearable device, or a gaming console); the components and/or capabilities of the auxiliary device 204 (e.g., display, processors, memory, input and output devices, network and communication devices, and graphics coprocessor); the applications 116 and data utilized by the user 102 with the auxiliary device 204; the particular activities performed by the user 102 on the auxiliary device 204; and the circumstances of the interaction of the user 102 with the auxiliary device 204, such as the date, time, and place of such user interaction, and other individuals in the presence of the user 102 during the user interaction). According to the device properties 208 of the auxiliary device 204, the primary device 202 determines 212 a user context 108 of the user interaction of the user 102 with the auxiliary device 204. The primary device 202 may then adapt 220 one or more elements of the computing environment 216 to be presented on the auxiliary device 204, where such adapting 220 is performed according to the user context 108 of the auxiliary device 204. For example, the primary device 202 may adapt the user interface, input/output devices and/or modalities, the set of applications, the accessible data, the contacts, website bookmarks, user accounts and credentials, and/or task flows of the device 204 according to the user context 108 of the auxiliary device 204. The primary device 202 then transmit 222, to the respective auxiliary devices 204, the computing environment that has been adapted 220 for the user context 108 of the auxiliary device 204, in accordance with the techniques presented herein.

### C. Technical Effects

The use of the techniques presented herein to present a computing environment 216 adapted for the user context 108 of the user interaction of the user 102 with respective auxiliary devices 204 of a device collection 104 may result in a variety of technical effects.

As a first example of a technical effect that may be achievable by the techniques presented herein, a device 104 utilizing the techniques presented herein may automatically adapt the computing environment 216 to reflect the user context 108 of an auxiliary device 204, thereby reducing the burden upon the user 102 in selecting, implementing, and maintaining the configuration of the computing environment 216 of the respective auxiliary devices 204. Moreover, if the user 102 does not have the motivation, technical proficiency, and/or resources to configure and maintain the auxiliary devices 204 for specific user contexts 108, the techniques presented herein may enable an automated adaptation 220 of the computing environment 216 that exhibits such flexibility.

As a second example of a technical effect that may be achievable by the techniques presented herein, a device 104 utilizing the techniques presented herein may facilitate the consistency of the presentation of the computing environment 216 across the auxiliary devices 204. As a first such example, an application 116 that is installed in the computing environment 216 of the primary device 202 may be automatically transmitted to each of the auxiliary devices 204 exhibiting a user context 108 with which the application 116 is associated, rather than the user 102 having to identify each such auxiliary device 204 and install the application 116 thereupon. Conversely, the techniques presented herein enable the primary device 202 to identify which auxiliary devices 204 do not reflect a user context 108 in the user interaction with the user 102 that is associated with the application 116, and may refrain from transmitting the application 116 to such auxiliary devices 204, thereby conserving computational resources. Such adaptation 220 may therefore promote the consistency of the presented computing environment 216 presented by each auxiliary device 204, while reducing the divergence of auxiliary devices 204 due to specialization for user contexts 108, and while further mitigating an enforcement of generalized and/or comprehensive configuration of the computing environment 216 to exhibit uniformity that diminishes the adaptation of each auxiliary device 204 to a particular user context 108.

As a third example of a technical effect that may be achievable by the techniques presented herein, the primary device 202 may automatically determine the user context 108 based upon the device properties 208 of the respective auxiliary devices 204, and may automatically adapt 220 the computing environment 216 to the user context 108 of the user interaction of the user 102 with the auxiliary device 204. Such automated determination may alleviate the individual 102 of having to specify such information explicitly for each auxiliary device 204. Such automated determination may also reduce user error in failing to specify the user context 108 consistently for each user interaction with each auxiliary device 204 (e.g., automatically adapting 220 the computing environment 216 to send messages through a particular email account that is associated with a current user context 108, rather than through an unintended email account that is associated with a former user context 108). Moreover, the particular architecture presented herein, wherein the primary device 202 determines the user contexts 108 of the user interaction of the user 102 in interacting with the auxiliary devices 204 of the device collection 104, may enable a more accurate and responsive automatic determination of the user context 108; e.g., any particular auxiliary device 204 may not have enough information to determine the user context 108 of the user 102 while interacting with that particular auxiliary device 204, but a centralized determination may be able to cluster the activities of the user 102 into user contexts 108 in order to determine the particular user context 108 of each auxiliary device 204. As further architectural variations, the primary device 202 and/or auxiliary devices 204 of the device collection 102 may be organized in various ways (e.g., exhibiting server/client and/or peer-to-peer relationships), and the primary device 202 may also be included in the device collection 104 as an auxiliary device 204 or may be separate from the device collection 104.

As a third example of a technical effect that may be achievable by the techniques presented herein, the user 102 may be able to expand the device collection 104 to include a larger number and/or variety of auxiliary devices 204 without entailing a heightened administrative burden. For example, the device collection 104 may include auxiliary devices 104 that are not capable of determining and/or adapting 220 the computing environment 216 to the user context 108 of the user 102 (e.g., a pair of headphones may be unable to determine the user context 108 due to insufficient access to relevant data and/or inadequate computational resources). However, configuring the primary device 202 to determine the user context 108 of the user 102 while interacting with a particular auxiliary device 204 may enable the primary device 202 to adapt 220 the computing environment 216 of an auxiliary device 204 that lacks such capability to achieve the determination and/or adaptation 220. These and other technical effects may be achievable through various implementations of the techniques presented herein.

### D. Example Embodiments

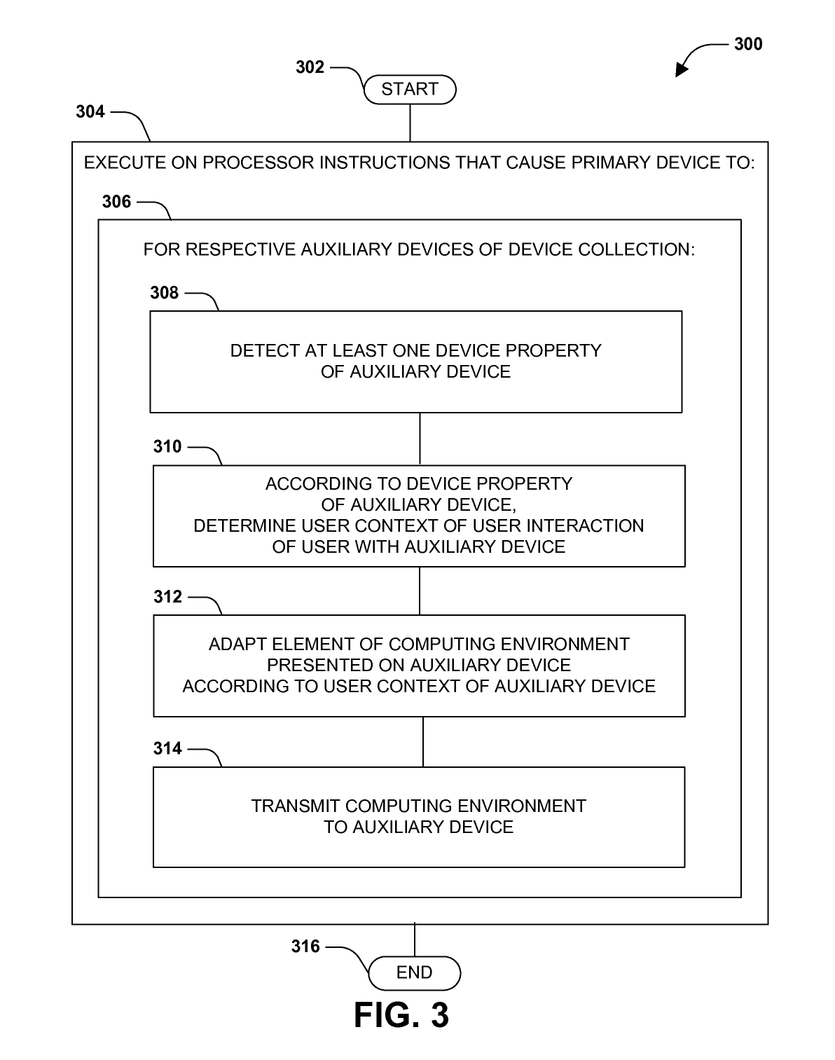

FIG. 3 presents a first example embodiment of the techniques presented herein, illustrated as an example method 300 of configuring a primary device 202 to present a computing environment 216 on auxiliary devices 204 of a device collection 104. The example method 300 may be implemented, e.g., as a set of instructions stored in a memory component of the primary device 202, such as a memory circuit, a platter of a hard disk drive, a solid-state storage device, or a magnetic or optical disc, and organized such that, when executed on a processor of the device, cause the primary device 202 to operate according to the techniques presented herein.

The example method 300 begins at 302 and involves executing 304 the instructions on a processor of the primary device 202. Specifically, executing 304 the instructions on the processor causes the primary device 202 to, for the respective 306 auxiliary devices 204 of the device collection 104, detect 308 at least one device property 208 of the auxiliary device 204. Executing 304 the instructions on the processor further causes the primary device 202 to, for the respective 306 auxiliary devices 204 and according to the device properties 208 of the auxiliary device 204, determine 310 a user context 108 of a user interaction of the user 102 with the auxiliary device 204. Executing 304 the instructions on the processor further causes the primary device 202 to, for the respective 306 auxiliary devices 204, adapt 312 at least one element of the computing environment 216 presented on the auxiliary device 204 according to the user context 108 of the auxiliary device 204. Executing 304 the instructions on the processor further causes the primary device 202 to, for the respective 306 auxiliary devices 204 transmit 314 the computing environment 216 to the auxiliary device 204. In this manner, the instructions cause the primary device 202 to present the computing environment 216 to the user 102 through the auxiliary device 204 and according to the user context 108 of the user interaction of the user 102 with the auxiliary device 204, and so ends at 316.

A second example embodiment of the techniques presented herein (not illustrated) involves an example method of configuring an auxiliary device 204 to present a computing environment 216 to a user 102 that has been transmitted by a primary device 202 of the device collection 104, where the computing environment 216 has been adapted to reflect a user context 108 of a user interaction of a user 102 with the auxiliary device 204. An example method of achieving this effect may comprise, e.g., executing on a processor of the auxiliary device 204 instructions that cause the auxiliary device 204 to detect at least one device property 208 of the auxiliary device indicating a user context in which the user interacts with the auxiliary device; transmit the at least one device property 208 to the primary device 202; and responsive to receiving the computing environment 216 from the primary device 202 having at least one element that has been adapted according to the user context 108 of a user interaction of the user 102 with the auxiliary device 204, present the computing environment 216 to the user 102. In this manner, the example method may enable an auxiliary device 204 to present the computing environment 216 to the user 102 in accordance with the techniques presented herein.

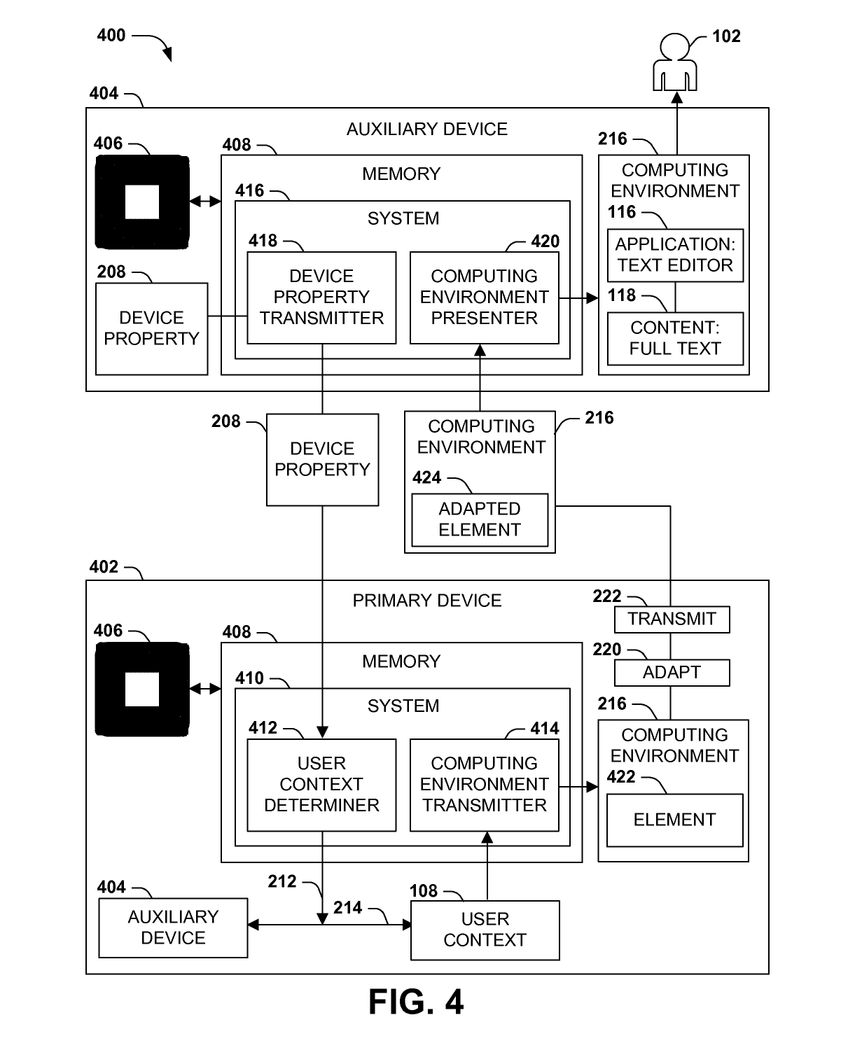

FIG. 4 presents further example embodiments of the techniques presented herein, illustrated as example systems respectively implemented on an example primary device 402 and an example auxiliary device 404 that implement at least a portion of the techniques presented herein. The example primary device 402 also hosts and/or manages a computing environment 216 comprising at least one element 422 (e.g., user interface, applications, visual features such as fonts and color schemes, data, application configurations, contact lists, and user accounts and credentials), and the example auxiliary device 404 also exhibits at least one device property 208 (e.g., a device type, hardware or software components and/or capabilities thereof, applications 116 installed and/or used by the user 102, documents and other objects accessed by the user 102, and/or circumstances in which the user 102 interacts with the example auxiliary device 404). Further, in this exemplary scenario 400, the example primary device 402 and the example auxiliary device 404 each include a processor 406 and a memory 408 where an example system causes respective example device to present a computing environment 216 to a user 102 in accordance with the techniques presented herein. The respective example systems may be implemented, e.g., as a set of components respectively comprising a set of instructions stored in the memory 408 of the respective example devices, where the instructions of respective components, when executed on the processor 406, cause the example device to operate in accordance with the techniques presented herein. Alternatively, the respective components may be implemented as a discrete circuit or hardware device, or a combination thereof, that operate in accordance with the techniques presented herein

The example primary device 402 includes a first example system 410 comprising a user context determiner 412 that detects at least one device property 208 of the example auxiliary device 404, which indicates a user context 108 of a user interaction of the user 102 with the example auxiliary device 404, and, according to the at least one device property 208, determines the user context 108 of the user interaction of the user 102 with the example auxiliary device 404. The example system 410 also includes a computing environment transmitter 414, which adapt 220 at least one element 422 of the computing environment 216 to be presented on the auxiliary device according to the user context 108 of the example auxiliary device 404, and transmit 222 the computing environment 216 including the adapted element 422 to the example auxiliary device 404.

The example auxiliary device 404 includes a second example system 416 that includes a device property transmitter 418, which detects at least one device property 208 of the example auxiliary device 404 indicating a user context 108 in which the user 102 interacts with the example auxiliary device 404, and transmits the at least one device property 208 of the example primary device 402. The example system 416 of the example auxiliary device 404 also includes a computing environment presenter 420, which, responsive to receiving, from the example primary device 402, a computing environment 216 having at least one element 422 that has been adapted according to the user context 108 of a user interaction of the user 102 with the example auxiliary device 404, presents the computing environment 216 to the user 102. In this manner, the interoperation of the example primary device 402 and the example auxiliary device 404 utilizing such example systems may enable a cooperative presentation of the computing environment 216 to the user 102 in accordance with the techniques presented herein.

Still another embodiment involves a computer-readable medium comprising processor-executable instructions configured to apply the techniques presented herein. Such computer-readable media may include various types of communications media, such as a signal that may be propagated through various physical phenomena (e.g., an electromagnetic signal, a sound wave signal, or an optical signal) and in various wired scenarios (e.g., via an Ethernet or fiber optic cable) and/or wireless scenarios (e.g., a wireless local area network (WLAN) such as WiFi, a personal area network (PAN) such as Bluetooth, or a cellular or radio network), and which encodes a set of computer-readable instructions that, when executed by a processor of a device, cause the device to implement the techniques presented herein. Such computer-readable media may also include (as a class of technologies that excludes communications media) computer-computer-readable memory devices, such as a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a CD-R, DVD-R, or floppy disc), encoding a set of computer-readable instructions that, when executed by a processor of a device, cause the device to implement the techniques presented herein.

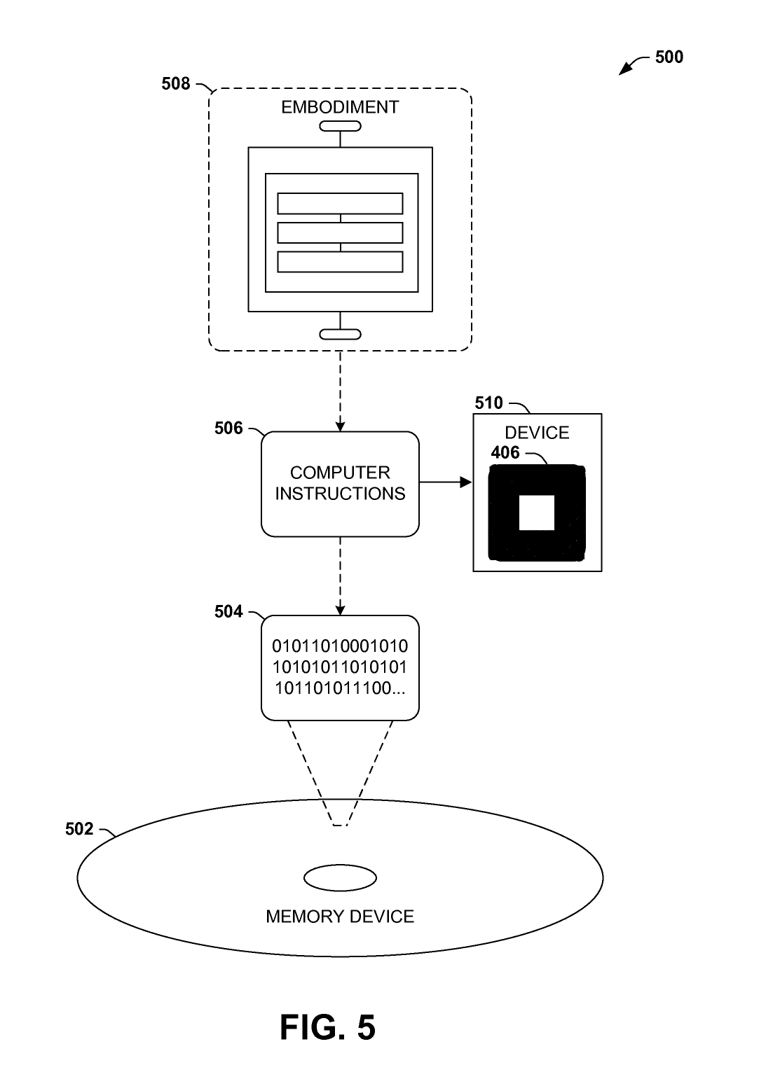

An example computer-readable medium that may be devised in these ways is illustrated in FIG. 5, wherein the implementation 500 comprises a computer-readable memory device 502 (e.g., a CD-R, DVD-R, or a platter of a hard disk drive), on which is encoded computer-readable data 504. This computer-readable data 504 in turn comprises a set of computer instructions 506 that, when executed on a processor 406 of a device 510, cause the device 510 to operate according to the principles set forth herein. In a first such embodiment, the processor-executable instructions 506 may cause a primary device 202 to present a computing environment 216 to a user 102 through one or more auxiliary devices 204 of a device collection 104, such as the example method 300 of FIG. 3. In a third such embodiment, the processor-executable instructions 506 may cause a primary device 202 and/or an auxiliary device 204 to implement a system for presenting a computing environment 216 to a user 102, such as the example systems presented in the example scenario 400 of FIG. 4. Many such computer-readable media may be devised by those of ordinary skill in the art that are configured to operate in accordance with the techniques presented herein.

### E. Variations

The techniques discussed herein may be devised with variations in many aspects, and some variations may present additional advantages and/or reduce disadvantages with respect to other variations of these and other techniques. Moreover, some variations may be implemented in combination, and some combinations may feature additional advantages and/or reduced disadvantages through synergistic cooperation. The variations may be incorporated in various embodiments (e.g., the example method 300 of FIG. 3; the example systems of FIG. 4; and the example memory device 502 of FIG. 5) to confer individual and/or synergistic advantages upon such embodiments.

E1. Scenarios

A first aspect that may vary among embodiments of these techniques relates to the scenarios wherein such techniques may be utilized.

As a first variation of this first aspect, the techniques presented herein may be utilized to achieve the configuration of a variety of devices 106 of a device collection 104, such as workstations, laptops, tablets, mobile phones, game consoles, portable gaming devices, portable or non-portable media players, media display devices such as televisions, appliances, home automation devices, computing components integrated with a wearable device integrating such as an eyepiece or a watch, and supervisory control and data acquisition (SCADA) devices.

As a second variation of this first aspect, the techniques presented herein may be utilized with a variety of applications 116 presented within the computing environment 216, such as office productivity applications; media presenting applications, such as audio and video players; communications applications, such as web browsers, email clients, chat clients, and voice over IP (VoIP) clients; navigation applications, such as geolocation, mapping, and routing applications; utilities, such as weather and news monitoring applications that present alerts to the user 102; and games. Moreover, the applications 116 of the computing environment may involve a presentation of content 118 through one or more presentation modalities, such as text, images, live and/or prerecorded video, sound effects, music, speech, tactile feedback, three-dimensional rendering, and interactive and/or non-interactive user interfaces, as well as various techniques for receiving user input from the user 102, such as text input, pointing input, tactile input, gestural input, verbal input, and gaze tracking input.

As a third variation of this first aspect, the techniques presented herein may be utilized with a variety of architectures within and/or among the devices 106 of the device collection 104. As a first such example, the primary device 202 may also be part of the device collection 104 (e.g., a mobile phone of the user 102), and may therefore also operate as an auxiliary device 204. The user 102 may designate various auxiliary devices 204 as the primary device 202 at different times and/or under different circumstances. Alternatively, the primary device 202 may be outside of the device collection 104, and may interact with the device collection 104 in order to drive the computing environment 216 to the respective auxiliary devices 204. As a second such example, the respective devices 106 may utilize components that are directly and physically connected to the device 106, such as wired displays, speakers, and headphones. As a third such example, the respective devices 106 may utilize one more components that are accessible via a wireless connection, such as a radiofrequency. As a fourth such example, the respective devices 106 may communicate over a personal-area, local-area, and/or wide-area network in order to interoperate according to the techniques presented herein. As a fifth such example, the respective device 106 may utilize one or more components that are accessible through a second device 106 of the device collection 104, such as in a client/server or peer-to-peer architecture. Moreover, the respective devices 106 of the device collection 104 may be utilized by one user 102 or a group of users 102, and/or may be controlled by at least one first user 102 on behalf of one or more other users 102. These and other scenarios may be suitable for the presentation of a computing environment 216 on the respective devices 106 of a device collection 104 in accordance with the techniques presented herein.

E2. Device Properties and Determining User Context

A second aspect that may vary among embodiments of the techniques presented herein relates to the device properties 208 exhibited by each auxiliary device 204, and the manner in which a primary device 202 determines the user context 108 of the user interaction of the user 102 with the respective auxiliary devices 204 according to the device properties 208 of the respective auxiliary devices 204.

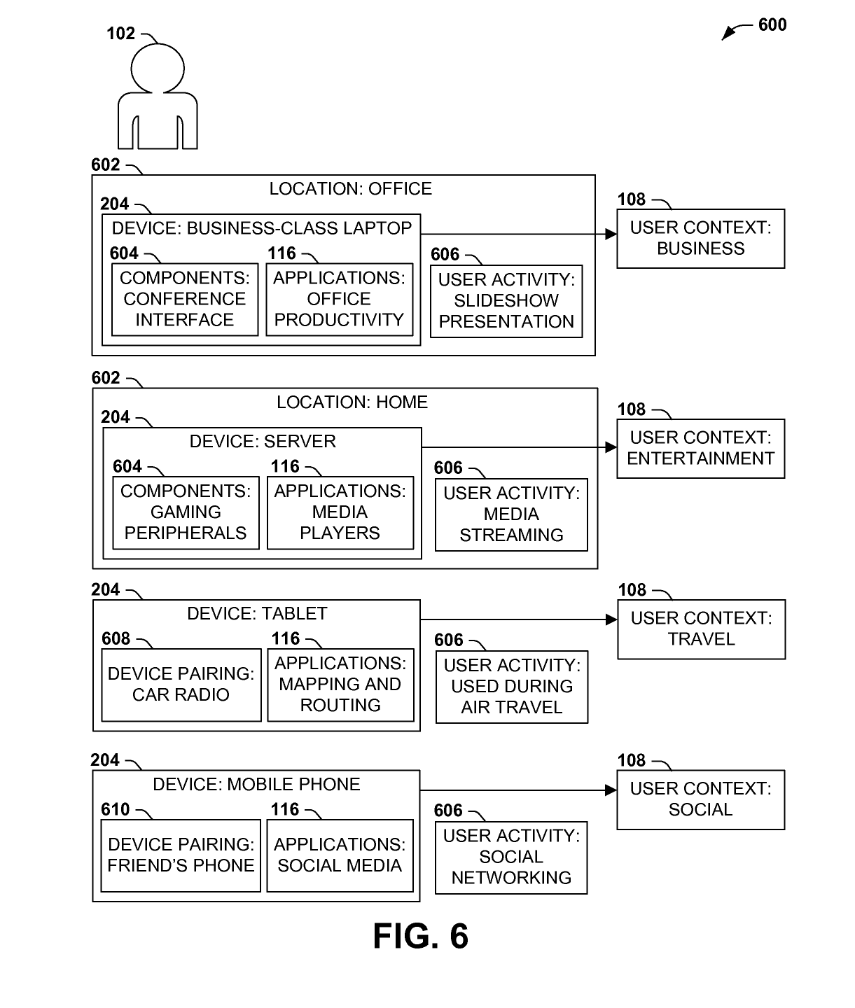

FIG. 6 presents an illustration of an example scenario 600 in which the user context 108 of the user interaction of the user 102 with respective auxiliary devices 204 of the device collection 104 is determined by monitoring the usage of the respective auxiliary devices 204 by the user 102. In this example scenario 600, the user 102 interacts with various auxiliary devices 204 in different ways and circumstances, according to which the user context 108 may be determined by a primary device 202 of the device collection 104.

As a first variation of this second aspect presented in the example scenario 600 of FIG. 6, the user context 108 of the user interaction of the user 102 may be determined according to a device type of the respective auxiliary devices 204. For example, the first auxiliary device 204 comprises a business-class laptop, which features components 604 such as a teleconferencing device and office productivity applications 116, which may indicate that the user context 108 of the first auxiliary device 204 is used for academic or professional tasks of the user 102. A second auxiliary device 204 comprises a server featuring components 604 such as a graphics coprocessor, a theater-quality display and speakers, and gaming peripherals, applications 116 such as media players, and an account with a movie and/or music streaming service, which together indicate the user context 108 of the second auxiliary device 204 for home entertainment. Similarly, a third auxiliary device 204 that features components 604 such as a geopositioning device and applications 116 such as mapping and routing may be identified according to the user context 108 of a travel device; and a fourth auxiliary device 204 that features components 604 such as a camera and applications 116 such as a social media interface may be identified with a user context 108 of social interaction. Alternatively or additionally, a primary device 202 may identify the user contexts 108 of the respective auxiliary devices 204 according to the user activities 606 of the user 102 performed with each auxiliary device 204; e.g., an auxiliary device 204 may present a comprehensive and generalized set of applications 116 that enable a variety of user activities 606, but the user 102 may selectively perform only a few user activities 606 on the auxiliary device 204, such as editing documents and viewing presentations (e.g., a business user context 108); only viewing movies and playing games (e.g., a home entertainment user context 108); or only using the mapping and routing applications 116 of the auxiliary device 204 (e.g., a travel user context 108). By monitoring such user activities 606 while the user 102 interacts with particular auxiliary devices 204, the primary device 202 may determine a user role of the user during the user interaction of the user with a particular auxiliary device 204 (e.g., the user 102 routinely interacts with the first auxiliary device 204 while operating in the role of a professional, and routinely interacts with the fourth auxiliary device 204 while operating in the role of a family member or a friend), and may adapting the computing environment 216 presented on the auxiliary device 204 according to at least one task that relates to the user role of the user 102 during the user interaction with the auxiliary device 204 (e.g., when the user 102 is interacting with a particular auxiliary device 204 in the role of a student, the primary device 202 may adapt the computing environment of the auxiliary device 204 to facilitate reading, studying, and note-taking tasks).

As a second variation of this second aspect presented in the example scenario 600 of FIG. 6, the primary device 202 may determine the user contexts 108 of the respective auxiliary devices 204 according to the circumstances in which the user 102 interacts with the auxiliary device 204, e.g., the days, times, and/or places of such user interaction. For example, the user 102 may primarily interact with a first auxiliary device 602 in an office location 602; a second auxiliary device 602 in a home location; and a fourth auxiliary device 204 in social environments (e.g., a friend's house or a restaurant). The primary device 202 may perform such determinations, e.g., by comparing the detected locations of the auxiliary devices 602 with the user's address book or a location database to determine the types of locations 602 where the user 102 chooses to interact with the respective auxiliary devices 602, and/or with the user's calendar to determine the types of scheduled tasks in which the user 102 interacts with the respective auxiliary devices 204.

As a third variation of this second aspect presented in the example scenario 600 of FIG. 6, the primary device 202 may determine the user contexts 108 of the respective auxiliary devices 204 according to the other devices and/or individuals that the respective auxiliary devices 204 detect and/or interact with during the user interactions of the user 102 through the auxiliary device 204. For example, the third auxiliary device 204 may be routinely paired 608 with a car radio, and the primary device 202 may identify the user context 108 of the third auxiliary device 204 as a travel context; and the fourth auxiliary device 204 may be occasionally paired 610 with a friend's device, such as a friend's mobile phone, which may indicate a social user context 108. As a further example, the primary device 202 may determine that the user 102 often uses subsets of the auxiliary devices 204 together in a particular user context 108 (e.g., while operating in a professional context, the user 102 may often utilize both a particular set of headphones and a particular microphone to engage in business-related teleconferences, and may therefore associate each auxiliary device 204, and/or well as the combined use thereof, with the business user context 108).

Further variations of this second aspect relate to the manner in which the primary device 202 performs the determination of the user context 108 based on the device properties 208 of the auxiliary devices 204. For example, the device properties 208 of a particular auxiliary device 204 may conflict and/or change, and may therefore reflect an ambiguous and/or dynamic user role 108, which may be difficult to deduce as a particular user context 108. The primary device 202 may utilize a variety of techniques to determine the user context 108 in view of such conflicting, ambiguous, and/or dynamic device properties 208.

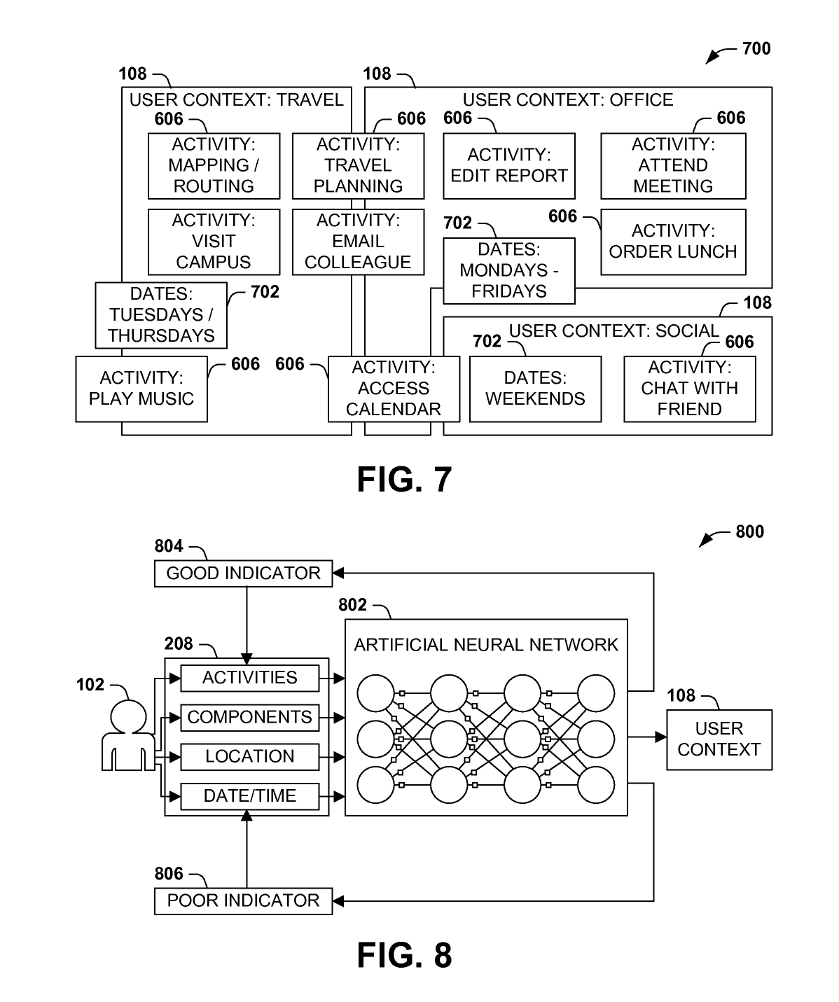

FIG. 7 presents an illustration of a first example scenario 700 featuring a first technique that the primary device 202 may utilize to identify the user context 108 of the user 102. In this example scenario 700, the primary device 20 detects various activities 606 performed by the user 102 while interacting with one or more auxiliary devices 204 and/or the circumstances 702 of various user interactions of the user 102 with various auxiliary devices 204, and attempts to identify the user contexts 108 of such auxiliary devices 204. Some activities 606 and/or circumstances 702 may be clear and consistent (e.g., the user 102 may always interact with auxiliary devices 204 in a student role while visiting a school campus), but other activities 606 and/or circumstances 702 may be ambiguous or variable (e.g., the primary device 202 may determine that the user 102 engages in travel-planning activities 606 both in a travel user context 108 and in a professional user context 108, and that the user 102 accesses the user's personal calendar during any such user context 108). Accordingly, the primary device 104 may cluster the activities 606 and/or circumstances 702, e.g., identifying correlational patterns of activities 606 and/or circumstances 702 that arise together for a particular auxiliary device 204. Bayesian classification techniques may be applied to achieve such classification, and may enable the primary device 202 to classify some device properties 208 as associated with other device properties 208 that are associated with a user context 108, and may thereafter determine the user context 108 of the user 102 according to the occurrence and/or detection of such correlated device properties 208.

FIG. 8 presents an illustration of a second example scenario 800 featuring an artificial neural network 802 that is capable of recognizing a user context 108. In this example scenario 800, the primary device 202 utilizes an artificial neural network 802 that has been trained, through a supervised and/or unsupervised training technique, to determine, from a set of device properties 208 that have been detected for a particular auxiliary device 204, a user context 108 of the user interaction of the user 102 with the auxiliary device 204. For example, the artificial neural network 802 may be provided with a training data set comprising various sets of device properties 208 and a known user context 108 with which the respective sets of device properties 208 are associated. The artificial neural network 802 may adjust the weights of internode synapses in order to adjust the output of the artificial neural network 802 toward the known-correct user context 108 for the respective device property sets. Such training may identify correlations between co-occurring device properties 208, and/or the confidence with which a particular device property 208 and/or set of device properties 208 indicate a particular user context 108 (e.g., deducing that some device properties 208 are a good indicator 804 of the user context 108 and may be utilized to achieve a high-confidence determination of user context, and that other device properties 208 are a poor indicator 806 of the user context 108 of the user 102 and are to be disregarded in determining the user context 108 of the user 102). Once trained, the artificial neural network 802 may be invoked by the primary device 202 to determine the user context 108 of the user interaction of the user 102 with various auxiliary devices 204. Moreover, the primary device 202 may continue to monitor the user activities 606 of the user 102 and may continue to adjust the artificial neural network 802 to detect and incorporate changes in the patterns of user activities 606 and/or circumstances 702 associating the auxiliary devices 204 with various user contexts 108. Many such adaptive algorithms and/or techniques may be utilized in the determination of the user context 108 of the user interaction of the user 102 with various auxiliary devices 204 in accordance with the techniques presented herein.

E3. Adapting Computing Environment

A third aspect that may vary among embodiments of the techniques presented herein relates to the manner in which the primary device 202 adapts 220 elements 422 of the computing environment 216 for presentation to the user 102 by an auxiliary device 204, and in accordance with the user context 108 of the user interaction of the user 102 with the auxiliary device 204.

As a first variation of this third aspect, the elements 422 of the computing environment 216 that may be adapted for various user contexts 108 include, e.g., a set or subset of applications within the computing environment 216 that are presented to the user 102 (e.g., a first set of applications 116 that the user 102 utilizes in various user context 108). Such elements 422 may also include a set or subset of files, such as documents and media objects (e.g., limiting the interaction of the user 102 with only a subset of the available documents and/or media objects). Such elements 422 may also include a contact list of the user 102 (e.g., limiting the contact list of the user 102 presented on each auxiliary device 204 to the contacts that are associated with the user context 108 of the user interaction of the user 102 with the auxiliary device 204). Such elements 422 may also include application configurations and/or modes (e.g., determining that the user 102 utilizes applications 116 to interact with media objects in a creation or editing mode while interacting with a first auxiliary device 204 in a first user context 108, and in a viewing or reading mode while interacting with a second auxiliary device 204 in a second user context 108). Such elements 422 may also include user accounts (e.g., determining that the user 102 sends email messages and communicates through a first user account while interacting with a first auxiliary device 204 in a first user context 108, and through a second user account while interacting with a second auxiliary device 204 in a second user context 108). Such elements 422 may also include bookmark lists (e.g., determining that the user 102 frequently visits a first set of websites while interacting with a first auxiliary device 204 in a first user context 108, and frequently visits a second set of websites while interacting with a second auxiliary device 204 in a second user context 108).

As a second variation of this third aspect, the elements 422 of the computing environment 422 may be adapted to utilize, or not utilize, various components of the respective auxiliary devices 204 according to the user context 108 of the user interaction of the user 102 with the auxiliary device 204. For example, a first auxiliary device 204 and a second auxiliary device 204 may each feature a set of speakers for playing audio, but the primary device 202 may determine that the first auxiliary device 204 is used in a professional context (e.g., presenting a presentation to a client), during which interruption by audio alerts may be undesirable, and that the second auxiliary device 204 is used in a casual user context 108 (e.g., at home), in which the user 102 is receptive to audio alerts. The primary device 202 may therefore adapt the computing environment 422 transmitted to the first auxiliary device 204 to refrain from using the speakers, particularly while the user 102 is presenting a presentation, and may adapt the computing environment 422 transmitted to the second auxiliary device 204 to utilize the speakers frequently for the presentation of audio alerts to the user 102.

As a third variation of this third aspect, the elements 422 of the computing environment 216 may be adapted to interact with the user 102 through various presentation modalities, based on the user context 108 of the user interaction of the user 102 with each auxiliary device 204. For example, the user 102 may prefer to interact with a first auxiliary device 204 (e.g., a workstation) using a full visual interface; with a second auxiliary device 204 (e.g., a mobile phone) using a condensed visual interface; and with a third auxiliary device 204 (e.g., a vehicle computer) using an audio-only interface. The computing environment 216 may therefore be adapted to utilize the respective presentation modalities on each auxiliary device 204 (e.g., presenting a full-text version of an article with full images and video on the first auxiliary device 204; a summary text version of the article, with images and video removed, on the second auxiliary device 204; and an audio transcript of the article on the third auxiliary device 204).

As a fourth variation of this third aspect, the elements 422 of the computing environment 216 may be adapted for various user contexts 108 to reflect other individuals with whom the user 102 interacts while utilizing the respective auxiliary devices 204 in a particular user context 108. That is, the primary device 202 may determine, concurrent with and related to the user interaction of the user 102 with the auxiliary device 204, an individual interaction between the user 192 and a particular individual (e.g., that the user 102 frequently plays games with another individual on a home theater device). The primary device 202 may therefore provide, within the computing environment 216 presented on the auxiliary device 204, an application 116 that is related to the individual interaction between the user 102 and the individual (e.g., presenting on the auxiliary device 204 a selection of two-player games that the user 102 and the individual may enjoy playing together). As another such example, the computing environment 216 may be adjusted to select, among at least two input components that provide user input, a selected input component for the user context 108 of the user interaction of the user 102 with various auxiliary device 204, and may bind various elements 422 of the computing environment 216 to the selected input components for different auxiliary devices 204 (e.g., presenting a full visual keyboard on a workstation device, a condensed visual keyboard on a mobile device, and a speech interface for a vehicle computer).

As a fifth variation of this third aspect, the elements 422 of the computing environment 216 may be adapted according to an environment privacy of the user interaction of the user 102 with the auxiliary device 204 (e.g., the user 102 may frequently utilize some auxiliary devices 204 in a public context, and other auxiliary devices 204 in a private context). The primary device 104 may therefore assess an exposure of the auxiliary device 204 to at least one other individual during the user interaction of the user 102 with the auxiliary device 204, and may adapt the elements 422 of the auxiliary device 204 according to such exposure (e.g., readily presenting personal and/or private information of the user 102 on auxiliary devices 204 that the user 102 utilizes in private, and adapting the computing environment 216 of other auxiliary devices 204 to present a warning or consent dialog before presenting such personal and/or private information of the user 102). As one such example, the primary device 202 may adapt a computing environment 216 in order to configure a password application 116 to display passwords for various accounts to the user 102 readily on auxiliary devices 204 that the user 102 utilizes in a public user context 108, and to obscure and/or refrain from displaying such passwords on other auxiliary devices 204 that the user 102 utilizes in a private user context 108.

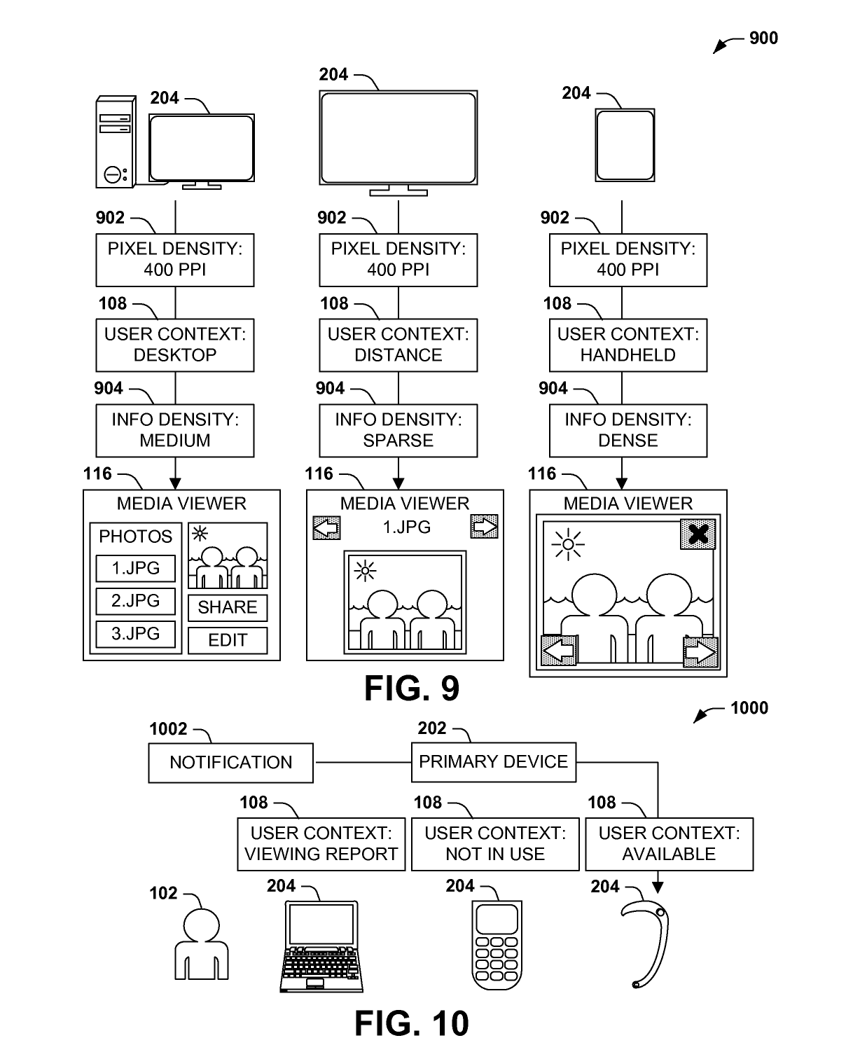

FIG. 9 presents an illustration of an example scenario 900 illustrating a sixth variation of this third aspect, in which various elements 422 of user interfaces presented within the computing environment 216 are adapted the user context 108 of the user 102 involving the viewing distance with which the user 102 engages the respective auxiliary devices 204. In this example scenario 900, the user 102 utilizes a set of auxiliary devices 204 respectively having a display that presents information at a particular pixel density 902. However, even though the displays of the respective auxiliary devices 204 feature the same pixel density 902, the user 102 may engage with the respective auxiliary devices 204 at different viewing distances; e.g., the device collection 102 may include a first auxiliary device 204 comprising a workstation that the user 102 engages from a distance of two feet, a second auxiliary device 204 comprising a home theater display that the user 102 engages from a ten-foot distance, and a third auxiliary device 204 comprising a handheld device that the user 102 engages at a very close and touchable distance. The viewing distance may indicate an information density 904 with which user interfaces of the computing environment 216 are to be presented to the user 102 on various auxiliary devices 204. For example, the user interface of an application 116 may be provided on the workstation auxiliary device 204 with a medium information density 904, e.g., an evenly and proportionally spaced layout of user controls and content; may be provided on the home theater auxiliary device 204 with a sparse information density 904, e.g., with plentiful space between user controls in view of the potentially imprecise input mechanisms of a 10-foot user interface, such as manual gestures and gaze tracking; may be provided on the handheld auxiliary device 204 with a dense information density 904, e.g., with a dense and overlapping user controls that maximize the viewing space of the user interface. In this manner, the computing environment 216 may be adapted to reflect variable information density 904 of the presentation components of the respective auxiliary devices 204.

FIG. 10 presents an illustration of an example scenario 1000 featuring a seventh variation of this third aspect, wherein a primary device 202 utilizes the user contexts 108 of the user interaction of the user 102 with various auxiliary devices 204 in order to route a notification 1002. In this example scenario 1000, the primary device 202 receives a notification 1002 to be presented to the user 1002, and select among the auxiliary devices 204 of the device collection 102 for presentation of the notification 1002 to the user 102. Such selection may be informed by the user contexts 108 of the auxiliary devices 204; e.g., the user 102 may be using a first auxiliary device 204 to present a report at a professional meeting, and may refrain from using a second auxiliary device 204 at all in a particular user context 108 device (e.g., the user 102 may keep his or her mobile phone in a pocket or purse during the meeting), but may be using a third auxiliary device 204 (e.g., an earpiece device) that is available and appropriate for presenting the notification 1002 in the user context 108. The primary device 202 may therefore transmit the notification 1002 to the selected device for presentation to the user 102. As an eighth variation of this third aspect, the primary device 202 may allow the user 102 to override the adaptation of the computing environment 216 on one or more auxiliary devices 204. Responsive to receiving a request to override the adapting of an element 422 of the computing environment 216 on the auxiliary device 204 with a second adaptation, the primary device 202 may apply the second adaptation of the element 422 of the computing environment 216 for presentation on the auxiliary device 204. For example, the primary device 202 may adapt the user interface 216 to present, on a selected auxiliary device 204, a constrained subset of applications 116 that are related to the user context 108 in which the user 102 interacts with the auxiliary device 204. However, if the user 102 requests to interact with a different application 116 that has not been included in the subset, either as one-time exception or as a persistent adaptation. The primary device 204 may therefore adjust the adaptation of the computing environment 216 for the selected auxiliary device 204 to include the selected application 116. Many such adaptations of the computing environment 216 of the respective auxiliary devices 204 may be utilized by the primary device 202 to adapt the computing environment 216 to the user context 108 of the user interaction of the user 102 with the auxiliary device 204 in accordance with the techniques presented herein.

E4. Transmitting and Presenting Computing Environment

A fourth aspect that may vary among embodiments of the techniques presented herein relates to the manner in which the primary device 202 transmits 222 the computing environment 216 to the auxiliary device 204, and in which the auxiliary device 204 presents the computing environment 216 to the user 102.

As a first variation of this fourth aspect, the primary device 202 may present the computing environment 216 to one or more auxiliary devices 204 by rendering the computing environment 216 and/or executing applications 116 on a processor of the primary device 202, while only receiving input and/or streaming video and/or audio output to the auxiliary device 204. Alternatively, the primary device 202 may send components to the auxiliary device 204 for use thereby; e.g., the primary device 202 may transmit an application 116 to the auxiliary device 204 for execution with an application configuration that is suitable for the user context 108 of the user interaction of the user 102 with the auxiliary device 204. As one such example, for respective applications 116 that are to be presented within the computing environment 216 on the respective auxiliary device 204, the primary device 202 may store at least two application variants of the application 116, wherein respective application variants are associated with a selected user context 108 of the user interaction of the user 102 with an auxiliary device 204. The primary device 202 may therefore adapt the elements 422 of an application 116 within the computing environment 216 for a particular auxiliary device 204 by identifying, among the at least two application variants, a selected application variant that is associated with the user context 108 of the user interaction of the user with the auxiliary device 204, and transmitting, to the auxiliary device 204, the computing environment 216 comprising the selected application variant of the respective applications 116 presented in the computing environment 116 of the auxiliary device 204.

As a second variation of this fourth aspect, an auxiliary device 204 may transmit the device properties 208 to the primary device 202 upon detecting a connection of the auxiliary device 204 to the primary device 202 (e.g., detecting that the auxiliary device 204 has joined a wired or wireless network through which the primary device 202 is accessible), and may initiate the presentation of the computing environment 216 to the user 102 upon detecting such connection. As one such variation, responsive to detecting the connection to the primary device 202, the auxiliary device 204 may present to the user 102 an offer to transition from a second computing environment of the auxiliary device 204 (e.g., a native environment that the auxiliary device 204 presents when not connected to the primary device 202) to the computing environment 216, and may initiate the presentation of the computing environment 216 only responsive to receiving an acceptance of the offer from the user 102. The auxiliary device 204 may also suspend the second computing environment while presenting to the user 102 the computing environment 216 received from the primary device 202, and/or, responsive to detecting an interruption of the connection to the primary device 202, resume presenting the second computing environment to the user 102. Many such configurations may be utilized to achieve the transmission of the computing environment 216 from the primary device 202 to the auxiliary device 204, and to present the computing environment on the auxiliary device 204 to the user 102, in accordance with the techniques presented herein.

### F. Computing Environment

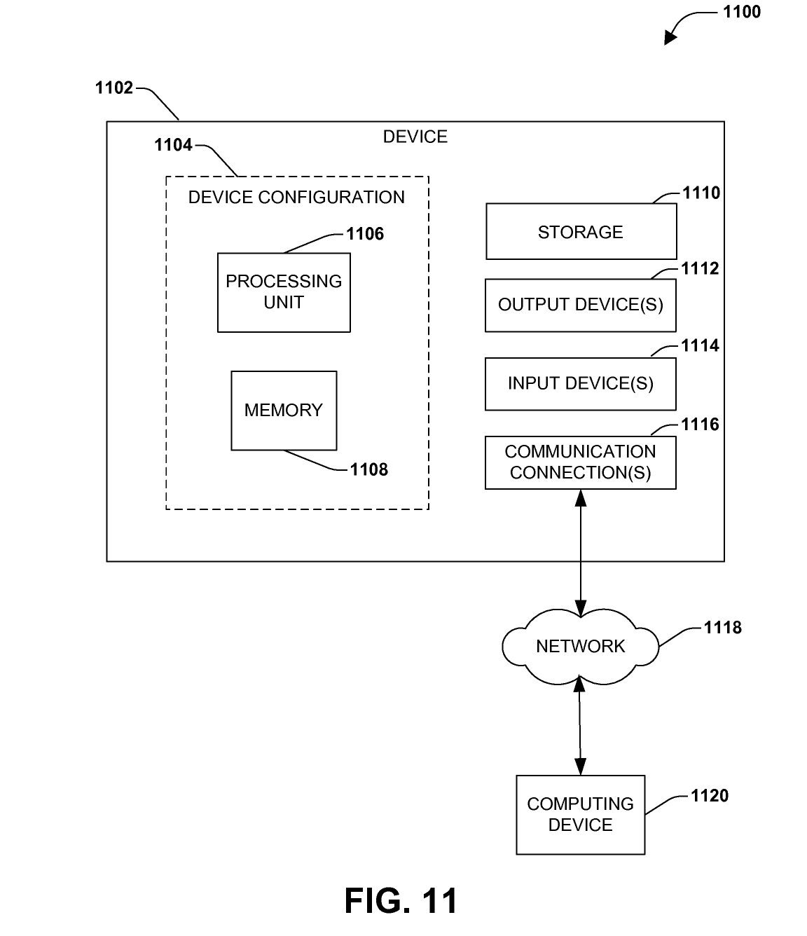

FIG. 11 and the following discussion provide a brief, general description of a suitable computing environment to implement embodiments of one or more of the provisions set forth herein. The operating environment of FIG. 11 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 11 illustrates an example of a system 1100 comprising a computing device 1102 configured to implement one or more embodiments provided herein. In one configuration, computing device 1102 includes at least one processing unit 1106 and memory 1108. Depending on the exact configuration and type of computing device, memory 1108 may be volatile (such as RAM, for example), non-volatile (such as ROM, flash memory, etc., for example) or some combination of the two. This configuration is illustrated in FIG. 11 by dashed line 1104.

In other embodiments, device 1102 may include additional features and/or functionality. For example, device 1102 may also include additional storage (e.g., removable and/or non-removable) including, but not limited to, magnetic storage, optical storage, and the like. Such additional storage is illustrated in FIG. 11 by storage 1110. In one embodiment, computer readable instructions to implement one or more embodiments provided herein may be in storage 1110. Storage 1110 may also store other computer readable instructions to implement an operating system, an application program, and the like. Computer readable instructions may be loaded in memory 1108 for execution by processing unit 1106, for example.

The term “computer readable media” as used herein includes computer-readable memory devices that exclude other forms of computer-readable media comprising communications media, such as signals. Such computer-readable memory devices may be volatile and/or nonvolatile, removable and/or non-removable, and may involve various types of physical devices storing computer readable instructions or other data. Memory 1108 and storage 1110 are examples of computer storage media. Computer-storage devices include, but are not limited to, RAM, ROM, EEPROM, flash memory or other memory technology, CD-ROM, Digital Versatile Disks (DVDs) or other optical storage, magnetic cassettes, magnetic tape, and magnetic disk storage or other magnetic storage devices.

Device 1102 may also include communication connection(s) 1116 that allows device 1102 to communicate with other devices. Communication connection(s) 1116 may include, but is not limited to, a modem, a Network Interface Card (NIC), an integrated network interface, a radio frequency transmitter/receiver, an infrared port, a USB connection, or other interfaces for connecting computing device 1102 to other computing devices. Communication connection(s) 1116 may include a wired connection or a wireless connection. Communication connection(s) 1116 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 1102 may include input device(s) 1114 such as keyboard, mouse, pen, voice input device, touch input device, infrared cameras, video input devices, and/or any other input device. Output device(s) 1112 such as one or more displays, speakers, printers, and/or any other output device may also be included in device 1102. Input device(s) 1114 and output device(s) 1112 may be connected to device 1102 via a wired connection, wireless connection, or any combination thereof. In one embodiment, an input device or an output device from another computing device may be used as input device(s) 1114 or output device(s) 1112 for computing device 1102.

Components of computing device 1102 may be connected by various interconnects, such as a bus. Such interconnects may include a Peripheral Component Interconnect (PCI), such as PCI Express, a Universal Serial Bus (USB), Firewire (IEEE 1394), an optical bus structure, and the like. In another embodiment, components of computing device 1102 may be interconnected by a network. For example, memory 1108 may be comprised of multiple physical memory units located in different physical locations interconnected by a network.

Those skilled in the art will realize that storage devices utilized to store computer readable instructions may be distributed across a network. For example, a computing device 920 accessible via network 1118 may store computer readable instructions to implement one or more embodiments provided herein. Computing device 1102 may access computing device 1120 and download a part or all of the computer readable instructions for execution. Alternatively, computing device 1102 may download pieces of the computer readable instructions, as needed, or some instructions may be executed at computing device 1102 and some at computing device 1120.

### G. Usage of Terms

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Any aspect or design described herein as an “example” is not necessarily to be construed as advantageous over other aspects or designs. Rather, use of the word “example” is intended to present one possible aspect and/or implementation that may pertain to the techniques presented herein. Such examples are not necessary for such techniques or intended to be limiting. Various embodiments of such techniques may include such an example, alone or in combination with other features, and/or may vary and/or omit the illustrated example.

As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated example implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method of enabling a primary device having a processor to present a computing environment on at least one auxiliary device of a device collection of a user, the method comprising:
executing, on the processor, instructions that cause the primary device to, for respective auxiliary devices of the device collection:
detect at least one device property of the auxiliary device;
according to the at least one device property of the auxiliary device, determine a user context of a user interaction of the user with the auxiliary device;
adapt at least one element of the computing environment presented on the auxiliary device according to the user context of the auxiliary device; and
transmit the computing environment to the auxiliary device.

2. The method of claim 1, wherein:
determining the user context further comprises: determining, concurrent with and related to the user interaction of the user with the auxiliary device, an individual interaction between the user and an individual; and
adapting the at least one element of the computing environment further comprises: providing within the computing environment presented on the auxiliary device, an application that is related to the individual interaction between the user and the individual.

3. The method of claim 1, wherein:
determining the user context further comprises: determining an environment privacy of the user interaction of the user with the auxiliary device; and
detecting the at least one device property of the auxiliary device further comprises: assessing an exposure of the auxiliary device to at least one other individual during the user interaction of the user with the auxiliary device.

4. The method of claim 1, wherein:
determining the user context further comprises: determining a user role of the user during the user interaction of the user with the auxiliary device; and
adapting the at least one element of the computing environment further comprises: adapting at least one element of the computing environment presented on the auxiliary device according to at least one task relating to the user role of the user during the user interaction with the auxiliary device.

5. The method of claim 1, wherein determining the user context of the user interaction of the user with the auxiliary device further comprises:
detecting at least one user activity performed by the user during the user interaction with the auxiliary device; and
determining the user context of the user interaction according to the at least one user activity performed by the user.

6. The method of claim 1, wherein determining the user context of the user interaction of the user with the auxiliary device further comprises:
detecting at least two user activities performed by the user during the user interaction of the user with the respective at least one auxiliary device of the device collection; and
clustering the at least two user activities performed by the user into at least two user contexts of the user.

7. The method of claim 1, wherein determining the user context of the user interaction of the user with the auxiliary device further comprises:
after determining a first user context of the user interaction of the user with the auxiliary device, monitoring at least one user behavior of the user with the device indicating a second user context of the user interaction of the user with the auxiliary device; and
responsive to determining the second user context, adjusting the at least one element of the computing environment presented on the auxiliary device according to the second user context of the auxiliary device.

8. An auxiliary device of a device collection utilized by a user and managed by a primary device, the auxiliary device comprising:
a processor; and
a memory storing instructions that, when executed on the processor, provide:
a device property transmitter that:
detects at least one device property of the auxiliary device indicating a user context in which the user interacts with the auxiliary device; and
transmits the at least one device property to the primary device; and
a computing environment presenter that, responsive to receiving, from the primary device, a computing environment having at least one element adapted according to the user context of a user interaction of the user with the auxiliary device, presents the computing environment to the user.

9. The auxiliary device of claim 8, wherein:
the device property transmitter transmits the at least one device property to the primary device responsive to detecting a connection to the primary device; and
the computing environment presenter initiates a presentation of the computing environment to the user.

10. The auxiliary device of claim 9, wherein:
the auxiliary device further comprises a second computing environment that is presented to the user prior to detecting the connection to the primary device; and
the computing environment presenter, responsive to detecting the connection to the primary device, suspends the second computing environment while presenting the computing environment received from the primary device to the user.

11. The auxiliary device of claim 10, wherein:
the computing environment presenter, responsive to detecting the connection to the primary device, present to the user an offer to transition the auxiliary device from the second computing environment to the computing environment; and
the computing environment presenter initiates the presentation of the computing environment to the user only responsive to receiving from the user an acceptance of the offer.

12. The auxiliary device of claim 10, wherein the computing environment presenter, responsive to detecting an interruption of the connection to the primary device, resumes presenting the second computing environment to the user.

13. A memory device storing instructions that, when executed on a processor of a primary device of a device collection, cause the primary device to present a computing environment to a user of the device collection comprising at least one auxiliary device, by, for respective auxiliary devices of the device collection:
detecting at least one device property of the auxiliary device;
according to the at least one device property of the auxiliary device, determining a user context of a user interaction of the user with the auxiliary device;
adapting at least one element of the computing environment presented on the auxiliary device according to the user context of the auxiliary device; and
transmitting the computing environment to the auxiliary device.

14. The memory device of claim 13, wherein:
the at least one device property of the auxiliary device further comprises a presentation component that presents content to the user within the computing environment; and
adapting the at least one element of the computing environment further comprises: adapting the at least one element of the computing environment to present the content to the user according to the user context of the user interaction of the user with the auxiliary device.

15. The memory device of claim 14, wherein:
the at least one device property of the auxiliary device indicates an information density of the presentation component of the auxiliary device; and
adapting the at least one element of the computing environment further comprises: adapting an information content of the at least one element of the computing environment according to the information density of the presentation component.

16. The method of claim 14, wherein executing the instructions further causes the primary device to present a notification to the user by:
among the at least two devices of the device collection, identify a selected device that is associated with a user context that is compatible with the notification; and
transmit the notification to the selected device for presentation to the user through the presentation component.

17. The memory device of claim 13, wherein:
the at least one device property of the auxiliary device further comprises at least two input components that provide user input to the computing environment; and
adapting the at least one element of the computing environment further comprises:
among the at least two input components, identify a selected input component according to the user context; and
bind the selected input component the at least one element of the computing environment.

18. The memory device of claim 13, wherein adapting the at least one element of the computing environment further comprises: presenting, within the computing environment of the auxiliary device, a constrained application set comprising at least one application that is associated with the user context of the user interaction of the user with the auxiliary device.

19. The memory device of claim 13, wherein:
executing the instructions further causes the primary device to, for respective applications presented in the computing environment, store at least two application variants of the application, wherein respective application variants are associated with a selected user context of the user interaction of the user; and
adapting the at least one element of the computing environment for the auxiliary device further comprises:
for the respective applications presented within the computing environment on the auxiliary device, identify, among the at least two application variants, a selected application variant that is associated with the user context of the user interaction of the user with the auxiliary device; and
transmitting the computing environment to the auxiliary device further comprising: transmitting, to the auxiliary device, the computing environment comprising, for the respective applications of the computing environment, the selected application variant of the application.

20. The memory device of claim 13, wherein executing the instructions further causes the primary device to, responsive to receiving from the user a request to override the adapting of the at least one element of the computing environment with a second adaptation of the computing environment presented on the auxiliary device, apply the second adaptation of the at least one element of the computing environment of the auxiliary device.
